(19) United States
(12) Patent Application Publication
(10) Pub. No.: US 2023/0174119 A1
(43) Pub. Date: Jun. 8, 2023

(54) SELF-PROPELLED RAILCAR

(71) Applicant: Intramotev Inc., Saint Louis, MO (US)

(72) Inventors: Timothy Luchini, Saint Louis, MO (US); Corey Vasel, Arnold, MO (US); Alex Peiffer, Columbus, OH (US); Stephen Sommerlot, Lansing, MI (US)

(21) Appl. No.: 18/063,383

(22) Filed: Dec. 8, 2022

Related U.S. Application Data
(60) Provisional application No. 63/287,270, filed on Dec. 8, 2021.

(51) Int. Cl. B61C 9/50; B61C 17/06; B61L 27/04; B61L 27/70

(52) U.S. Cl. CPC B61C 9/50; B61C 17/06; B61L 27/04; B61L 27/70

(57) ABSTRACT

A self-propelled railcar having a structure; at least one bogie attached to the structure, a sensor suite; a propulsion motor; and an energy storage system. The at least one bogie having at least one powered axle. The sensor suite has a processor and a plurality of sensors. The energy storage system includes a controller and a power source, wherein the controller provides energy from the power source to the propulsion motor to the powered axle in a predetermined manner to control movement of the self-propelled railcar. The energy storage system may be off-board.

### CROSS REFERENCE TO RELATED APPLICATION

The present patent application claims priority to U.S. Provisional Patent Application No. 63/287,270 filed on Dec. 8, 2021, the entire contents is hereby incorporated by reference.

### FIELD

The present application relates generally to rail transportation systems, in particular to a self-propelled railcar.

### BACKGROUND

A conventional train or “consist” (e.g., a set of railroad vehicles forming an entire train) typically includes a manned locomotive pulling a series of static railcars. This type of train model with manned locomotives requires an onboard crew to operate and monitor the train, which results in higher expenses. Additionally, having an onboard crew results in an increase in transportation time length. For long cross-country trips, the onboard crew needs to stop the train to rest when in principle the locomotive and railcars could continue the journey. This creates stoppages and slowdowns that could otherwise be prevented, which, in turn, adds to costs and delays.

In an effort to compensate for these higher operation costs, rail operators have increased the average number of static rail cars per train to spread the crew cost over more shipped freight; thus, increasing the train or consist lengths. The increase in train length results in an increase in train weight, which leads to longer stopping distances and slower starting speeds. In various conventional examples, a 100-car train may take well over a mile to stop and can only handle limited 1-3% grades without assistance from other locomotives or sanding systems to increase tractive effort on the driven wheels.

In view of the above, many rail operators have reduced labor and fuel burden per ton of cargo, which have led to larger rail yards for switching train cars and buildings. Rail yards facilitate the assembly of long trains as rail cars transporting cargo from multiple sources are queued and manually assembled through linkages. Such an assembly process is time consuming and prevents rail-based freight from competing with the speed of trucking shipments when specific delivery times are required. Furthermore, switching rail yards are limited in numbers and locations, thus increasing the variability in delivery times for rail-based freight. Moreover, the reconfiguration of trains and transfer of cargo from one train to another prevents visibility and accurate tracking of freight orders.

As shown above, there is an inverse relation between the cost per ton mile and the distance shipped. Over short distances, the cost to haul goods via train can be prohibitive, while over long distances the cost decreases. Small payloads on the scale of truck sizes are not economical for short haul train transit. Therefore, there is a need for an economical rail-based freight system to transport goods over both short and long distances.

### SUMMARY

A self-propelled railcar is disclosed according to an embodiment of the present invention. The self-propelled railcar comprises a structure; at least one bogie attached to the structure, a sensor suite; a propulsion motor; and an energy storage system. The at least one bogie comprises at least one powered axle. The sensor suite comprises a processor and a plurality of sensors. The energy storage system includes a controller and a power source, wherein the controller provides energy from the power source to the propulsion motor to the powered axle of the at least one bogie attached to the structure in a predetermined manner to control movement of the self-propelled railcar. In another embodiment, the energy storage system is located off-board.

In yet another embodiment, the self-propelled railcar comprises a structure; at least one bogie attached to the structure; a propulsion motor; a controller; a sensor suite; and an off-board energy storage system. The at least one bogie comprises at least one powered axle. The sensor suite comprises a processor and a plurality of sensors. The off-board energy storage system comprises a power source and the controller provides energy from the power source to the propulsion motor to the powered axle of the at least one bogie attached to the structure in a predetermined manner to control movement of the self-propelled railcar.

In yet another embodiment, the self-propelled railcar comprises a structure; at least one bogie attached to the structure, a sensor suite; a propulsion motor; an energy storage system; and an off-board energy storage system. The at least one bogie comprises at least one powered axle. The sensor suite comprises a processor and a plurality of sensors. The energy storage system includes a controller and a power source, wherein the controller provides energy from the power source to the propulsion motor to the powered axle in a predetermined manner to control movement of the self-propelled railcar. The off-board energy storage system includes a second controller and a second power source, wherein the second controller may, alternatively or additionally, provide energy from the second power source to the propulsion motor to the powered axle of the at least one bogie attached to the structure in a predetermined manner to control movement of the self-propelled railcar.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 illustrates a self-propelled railcar;

FIG. 2 illustrates a self-propelled railcar;

FIG. 3 illustrates a self-propelled railcar;

FIG. 4 illustrates a self-propelled railcar;

FIG. 5 illustrates a self-propelled railcar;

FIG. 6 illustrates a self-propelled railcar;

FIG. 7 is a schematic block diagram of the claimed self-propelled railcar;

FIG. 8 is a schematic block diagram of the claimed self-propelled railcar;

FIG. 9 is a schematic block diagram of the claimed self-propelled railcar;

FIG. 10 is a schematic block diagram of the claimed self-propelled railcar;

FIG. 11 is a schematic block diagram of the claimed self-propelled railcar;

FIG. 12 is a schematic block diagram of the claimed self-propelled railcar;

FIG. 13 is an example of a platoon of the claimed self-propelled railcar;

FIG. 14 is an example of a platoon of the claimed self-propelled railcar;

FIG. 15 is a schematic block diagram of decentralized communication between self-propelled railcars;

FIG. 16 is a schematic block diagram of centralized communication between self-propelled railcars;

FIG. 17 illustrates a self-propelled railcar with an off-board energy storage system; and

FIG. 18 illustrates a self-propelled railcar with an off-board energy storage system.

### DETAILED DESCRIPTION OF THE DRAWINGS

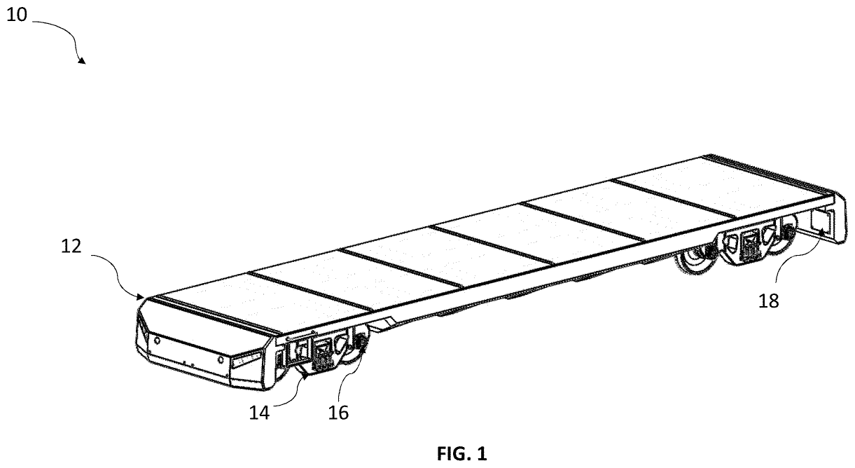

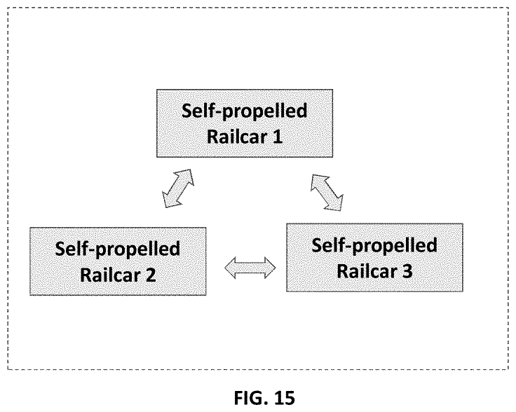

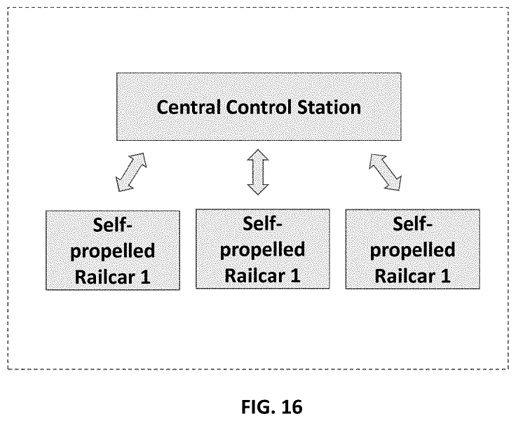

As illustrated in FIGS. 1-18, currently disclosed is a self-propelled railcar 10 comprising a structure 12, at least one bogie 14 attached to the structure 12, said bogie having at least one powered axle 16, a propulsion motor 42, a sensor suite 18, and an energy storage system 20. The sensor suite 18 comprises a processor 22 and a plurality of sensors 24. The energy storage system 20 comprises a controller 26 and a power source 28. The controller 26 provides energy from the power source 28 to propulsion motor 42 to the at least one powered axle 16 in a predetermined manner to control movement of the self-propelled railcar 10.

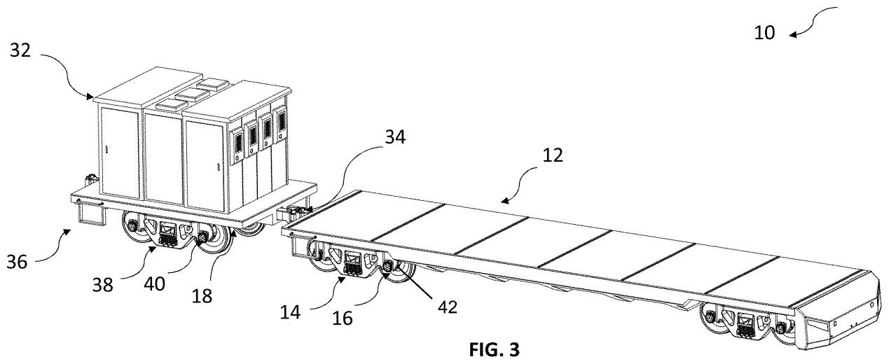

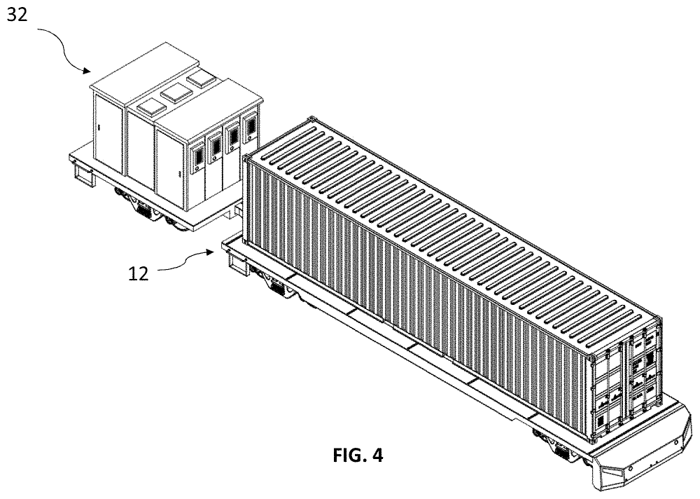

In another embodiment, as illustrated in FIGS. 3 and 4, the self-propelled railcar 10 comprises a structure 12, at least one bogie 14 attached to the structure 12, said bogie having at least one powered axle 16, a propulsion motor 42, a sensor suite 18, and an off-board energy storage system 32. The sensor suite 18 comprises a processor 22 and a plurality of sensors 24. The off-board energy storage system 32 comprising a controller 26 and a power source 28. The controller 26 provides energy from the power source 28 to the propulsion motor 42 to the at least one powered axle 16 in a predetermined manner to control movement of the self-propelled railcar 10.

In yet another embodiment, the self-propelled railcar 10 comprises a structure 12, at least one bogie 14 attached to the structure 12, said bogie having at least one powered axle 16, a propulsion motor 42, a sensor suite 18, a controller 26 and an off-board energy storage system 32. The sensor suite 18 comprises a processor 22 and a plurality of sensors 24. The off-board energy storage system 32 comprising a power source 28. The controller 26 provides energy from the power source 28 to the propulsion motor 42 to the at least one powered axle 16 in a predetermined manner to control movement of the self-propelled railcar 10.

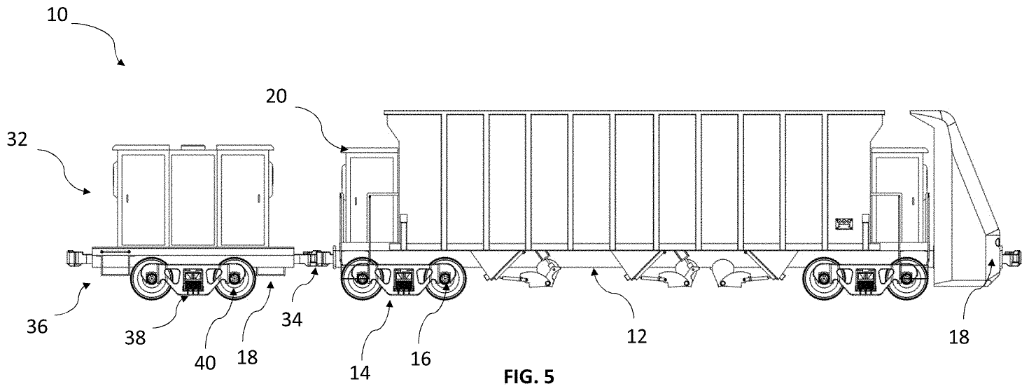

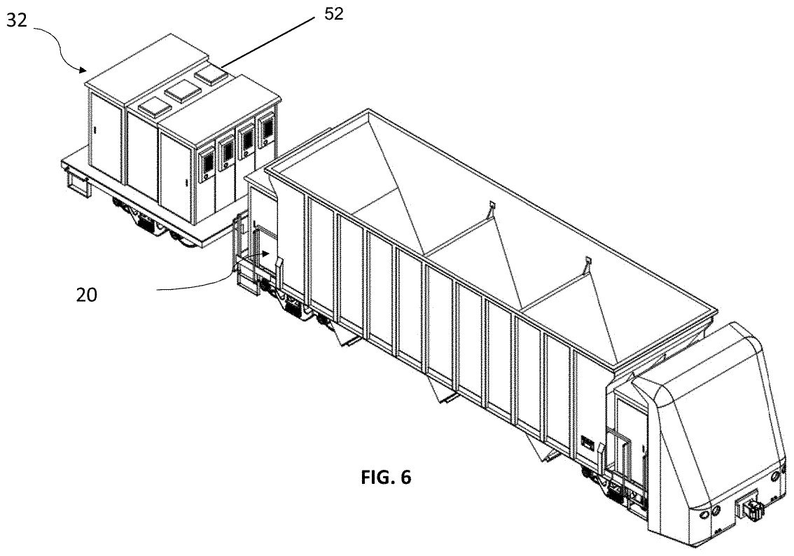

In yet another embodiment, as illustrated in FIGS. 5-6, the self-propelled railcar 10 comprises a structure 12, at least one bogie 14 attached to the structure 12, said bogie having at least one powered axle 16, a propulsion motor 42, a sensor suite 18, an energy storage system 20, and an off-board energy storage system 32. The sensor suite 18 comprises a processor 22 and a plurality of sensors 24. The energy storage system 20 comprises a controller 26 and a power source 28. The controller 26 provides energy from the power source 28 to propulsion motor 42 to the at least one powered axle 16 in a predetermined manner to control movement of the self-propelled railcar 10. The off-board energy storage system comprises a second controller and a second power source. The second controller may, alternatively or additionally, provide energy from the second power source to the propulsion motor to the powered axle of the at least one bogie attached to the structure 12 in a predetermined manner to control movement of the self-propelled railcar.

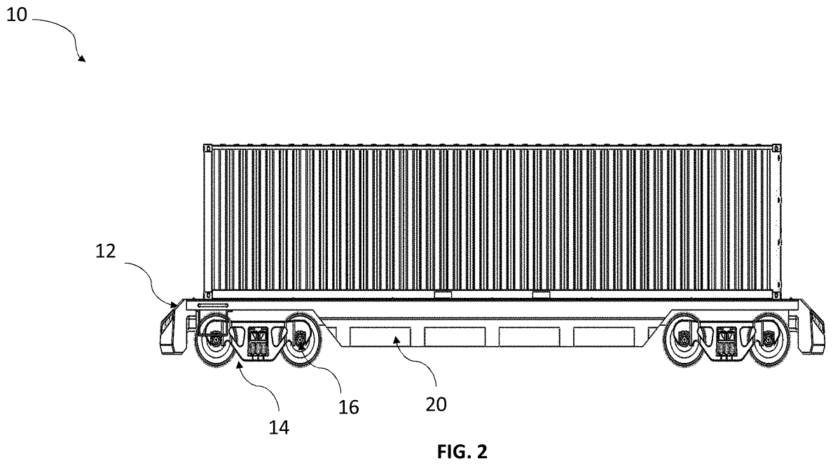

In any of the above described embodiments, the currently disclosed self-propelled railcar may be used for different types of haulage operations. As illustrated in FIGS. 1-4, structure 12 of the self-propelled railcar 10 may be reconfigured to haul different types of cargo, including flatbed, hopper, tanker, intermodal or other haulage operations. For example, FIG. 2 and FIG. 4 show the self-propelled railcar burdened with a standard ISO shipping container. FIG. 5 and FIG. 6 show the self-propelled railcar with a top load and bottom dump hopper configuration. The structure 12 may also be reconfigured for human transportation. Further, the structure 12 may be reconfigured for docking of aerial flying vehicles or drones.

As shown, the self-propelled railcar 10 includes at least one bogie 14 and a propulsion motor 42. The propulsion motor may be electrical or mechanical. At least one bogie 14 is attached to the structure 12 and has at least one powered axle 16. The energy storage system 20 or off-board energy storage system 32 provides energy to the propulsion motor, which then powers the at least one powered axle 16. As illustrated, the energy storage system 20 or off-board energy storage system 32 includes a controller 26 and a power source 28. The power source may include a battery, for example, lithium titanate oxide. The power source may further include directed energy, drivetrain, hydrogen drivetrain, hybrid generations, and large capacitors.

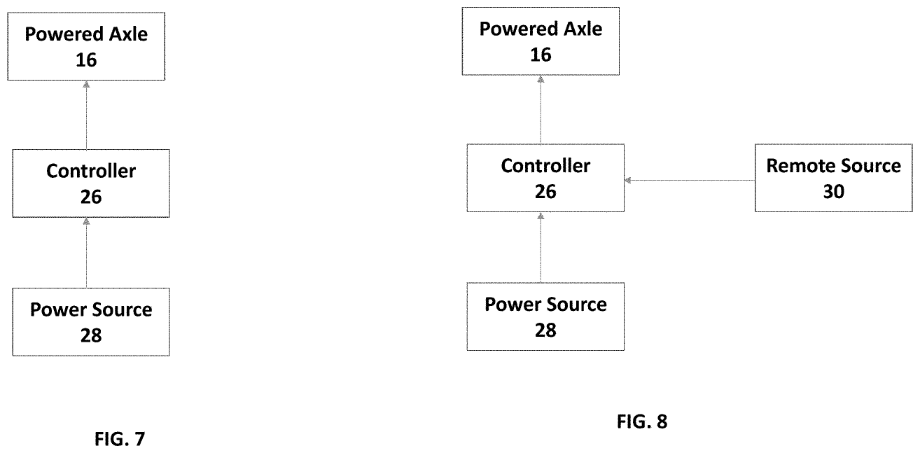

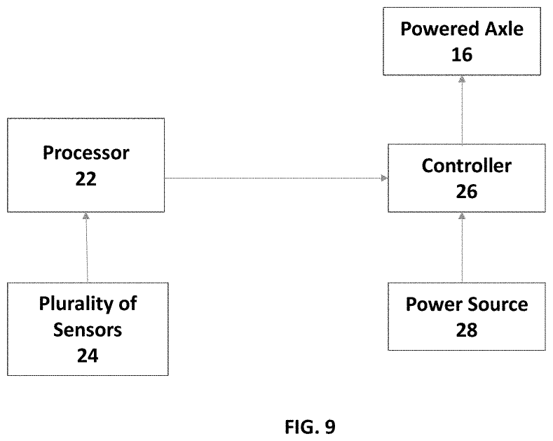

As illustrated in FIGS. 7 and 8, the controller 26 provides energy from the power source 28 to the propulsion motor 42 to the at least one powered axle 16 in a predetermined manner to control movement of the self-propelled railcar 10. As shown in FIG. 7, the controller 26 may operate autonomously to control the movement of the self-propelled railcar. Alternatively, or additionally, as shown in FIG. 8, the controller may receive commands from a remote source. Alternatively, or additionally, the controller may be manually operated from the self-propelled car.

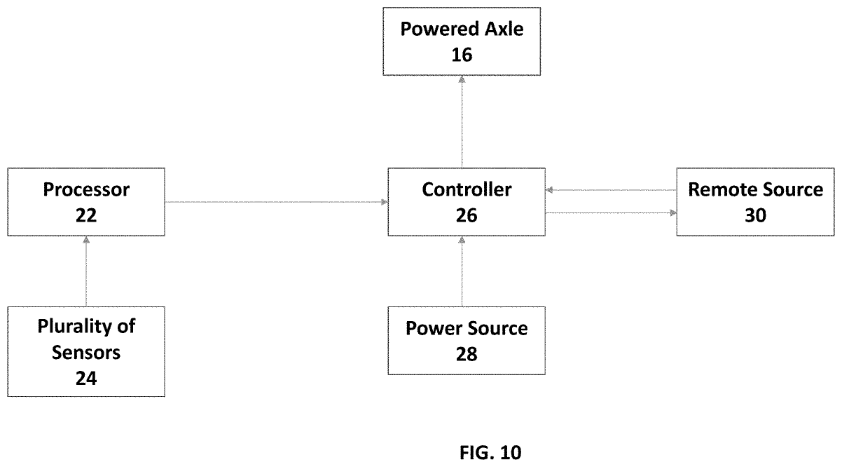

The self-propelled car comprises a sensor suite 18. The sensor suite 18 comprises a processor 22 and a plurality of sensors 24. The plurality of sensors may include front and rear cameras, radar, lidar, global positional system (GPS) tracking, adaptive speed controllers, and ultrasonic obstacle detection. As illustrated in FIGS. 9-10, at least one sensor of the plurality of sensors 24 collects information and then sends the same to the processor 22. The processor 22 gathers the information received from the plurality of sensors 24 and sends said information to the controller 26. As illustrated in FIG. 9, the controller 26 may then operate autonomously to control movement of the self-propelled railcar in accordance with the information received from the processor 22. For example, the controller 26 may increase or decrease the energy provided from the power source 28 to the powered axle 16 based on the information received from the processor 22 to accelerate or decelerate the self-propelled railcar.

Alternatively, or additionally, as shown in FIG. 10, the controller 26 may send the information received from the processor 22 to a remote source 30. The controller sends the information to the remote source via wireless communication strategy, for example, Wi-Fi, 4G or 5G networks. The remote source may include a central ground station with a central computer processor. The remote source 30 analyzes the information received from the controller 26 and then sends back commands to the controller. The controller, then, controls movement of the self-propelled railcar in conformance with said commands. For example, the controller 26 may increase or decrease the energy provided to the powered axle 16 from the power source 28 based on the commands received from the remote source 30 to accelerate or decelerate the self-propelled railcar.

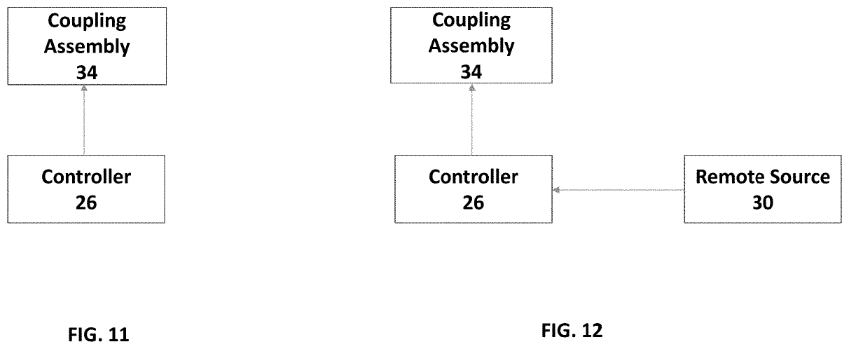

The self-propelled railcar may further comprise a coupling assembly 34. As illustrated in FIGS. 11-18, the self-propelled railcar provides for remote or autonomous coupling and decoupling in situ for platooning scenarios. The controller may autonomously operate the coupling assembly. Alternatively, or additionally, the controller may operate the coupling assembly in accordance to the commands received from the remote source 30. Alternatively, or additionally, the coupling assembly may be manually operated. The coupling assembly 34 allows another self-propelled railcar to be coupled to the self-propelled railcar. Alternatively, or additionally, the coupling assembly allows a traditional static railcar to be coupled to the self-propelled railcar 10. A traditional static railcar refers to a traditional unpowered and unmanned railcar.

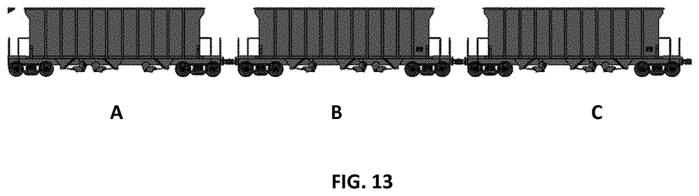

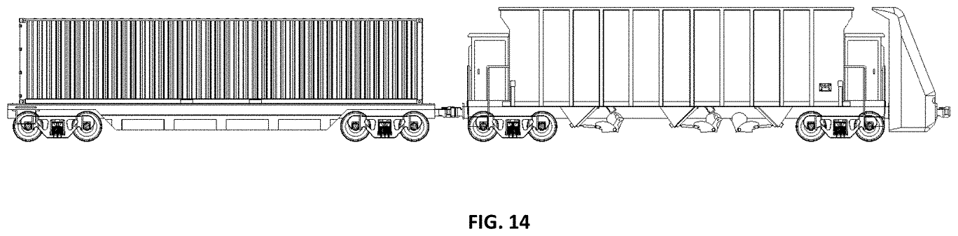

Coupling self-propelled rail cars provides for energy sharing between said railcars. Two or more self-propelled rail cars may be coupled together to share energy directly through an electrical connection. Alternatively, or additionally, two or more self-propelled rail cars may be coupled to share energy indirectly through shared kinetic energy and momentum. A self-propelled railcar may link to another self-propelled railcar while in transit sharing energy sources and coupling together to extend travel range. For example, FIG. 13 illustrates a platoon scenario wherein self-propelled railcar A needs to travel 200 miles, self-propelled railcar B needs to travel 400 miles, and self-propelled railcar C needs to travel 600 miles. Self-propelled car A can use its energy storage system by either pulling or pushing the self-propelled railcars B and C before disconnecting in route and allowing self-propelled railcar B and self-propelled railcar C to conserve each of their own energy storage systems for their corresponding longer routes.

A self-propelled railcar may communicate and coordinate with other self-propelled railcars. The communication structure between railcars may be wireless communication strategy over, for example, Wi-Fi, 4G or 5G networks. Additionally, or alternatively, the communication structure between railcars may be hardwired communication on Ethernet or can-bus, for example. The railcars may communicate directly between each other in a decentralized fashion, as illustrated in FIG. 12. As shown in FIG. 13, the railcars may also communicate in a centralized fashion wherein each railcar communicates with another railcar through the remote source, which may include a central control station.

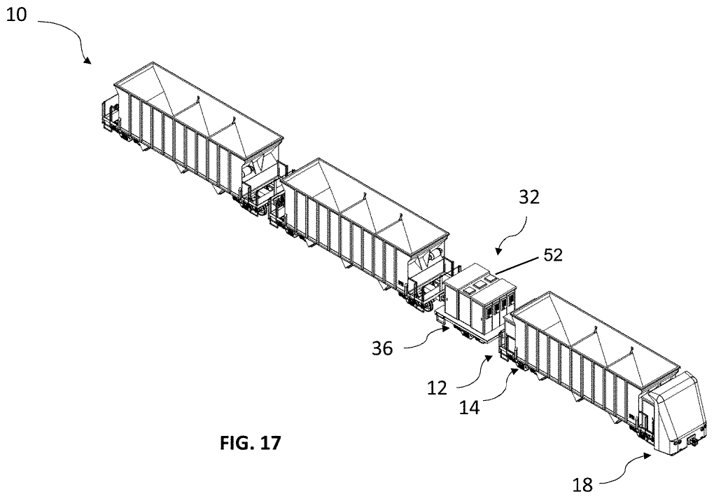

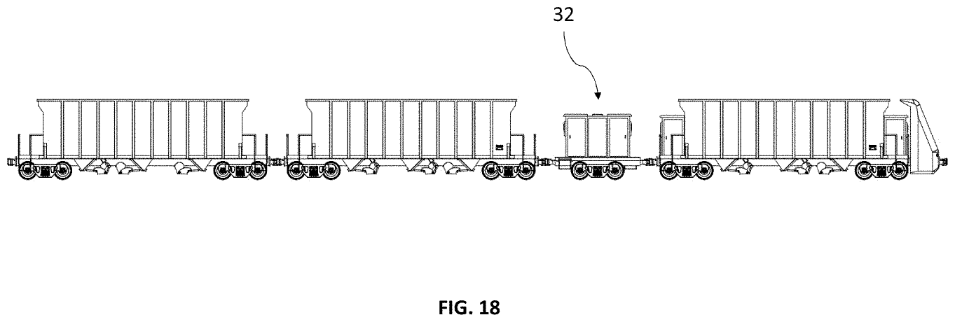

FIGS. 17-18 show self-propelled railcar 10 comprising structure 12, at least one bogie 14 attached to the structure 12, said bogie having at least one powered axle 16, a propulsion motor 42, a sensor suite 18, and the off-board energy storage system 32. The sensor suite 18 comprises processor 22 and plurality of sensors 24. The off-board energy storage system 32 includes controller 26 and power source 28. The controller 26 provides energy from the power source 28 to the propulsion motor 42 to the at least one powered axle 16 in a predetermined manner to control movement of the self-propelled railcar 10.

The off-board energy storage system may further comprise a vehicle 36 coupled to the structure 12. Said vehicle including at least one bogie 38 attached to the vehicle 36, the bogie having at least one powered axle 40, and a propulsion motor 44. Additionally, the off-board energy storage system may comprise a secondary power source 52. The controller 26 provides energy from the secondary power source 52 to the propulsion motor of the vehicle to the powered axle 40 of the at least one bogie 38 attached to the vehicle 36 in a predetermined manner to control movement of the vehicle. For example, the controller 26 may autonomously increase or decrease the energy provided from the secondary power source to the powered axle 40 to accelerate or decelerate the vehicle. In another example, the controller may control the energy provided from the secondary power source to the powered axle in accordance with the commands received from the remote source 30.

Having an off-board energy storage system provides numerous advantages over the current prior art. The off-board energy storage system provides for effective recharging and/or exchange of the power source reducing cycle time; therefore, decreasing fleet size and capital expenditure. The off-board energy storage system also provides for higher mechanical availability. As the power source of the off-board energy storage system, for example a battery, is depleted or expires, said power source may be replaced with a fully charged power source or a new power source without having to take the self-propelled railcar out of service. The self-propelled railcar may spend more time in motion and less time recharging the power source; thus, increasing the mechanical availability of the railcar. Moreover, the off-board energy storage system may also provide for a higher payload. Depending on the corresponding rail load limitations, the payload of a railcar is limited to 286K lbs or 315K lbs. By having an off-board energy storage system, the payload of the railcar is correspondingly increased by the weight of the off-board power source. A power source consisting of a battery may weigh 20K lbs. By having said battery off-board, the payload of the railcar may be increased by 10 tons.

As indicated above, the self-propelled railcar may communicate via wireless communication with the remote source and/or with another coupled or uncoupled self-propelled railcar. Additionally, different elements of the self-propelled railcar may communicate between each other via wireless communication. For example, the communication between the controller, the processor and/or sensor suite may be wireless. The controller of the self-propelled railcar communicates through a wireless adapter that translates the information into a radio frequency and transmits the same using an antenna. On the receiving end, a wireless router receives the signal and decodes the same sending the information to another computer, for example, to the processor, to the controller of another self-propelled railcar, or to the processor of the remote source. These can then use any existing standards (e.g. 802.11xx) for wireless communication or multiple standards in conjunction.

While this invention has been shown and described with respect to a detailed embodiment thereof, it will be understood by those skilled in the art that changes in form and detail thereof may be made without departing from the scope of the claims of the invention.

What is claimed:

1. A self-propelled railcar comprising:
a structure;
at least one bogie attached to the structure, the bogie having at least one powered axle;
a sensor suite, the sensor suite comprising a processor and a plurality of sensors;
a propulsion motor; and
an energy storage system, the energy storage system comprising a controller and a power source,
wherein the controller provides energy from the power source to the propulsion motor to the powered axle in a predetermined manner to control movement of the self-propelled railcar.

2. The self-propelled railcar as claimed in claim 1, wherein the energy storage system is off-board.

3. The self-propelled railcar as claimed in claim 2, the off-board energy storage system further comprising:
a vehicle coupled to the structure;
at least one bogie attached to the vehicle, the bogie having at least one powered axle; and
a propulsion motor.

4. The self-propelled railcar as claimed in claim 1, wherein the controller operates autonomously to control movement of the self-propelled railcar.

5. The self-propelled railcar as claimed in claim 1, wherein the controller receives commands from a remote source and controls movement of the self-propelled railcar in conformance with said commands.

6. The self-propelled railcar as claimed in claim 1, wherein the controller is manually operated.

7. The self-propelled railcar as claimed in claim 1, further comprising a coupling assembly.

8. The self-propelled railcar as claimed in claim 7, wherein the controller operates the coupling assembly in accordance with commands received from a remote source.

9. The self-propelled railcar as claimed in claim 7, wherein the coupling assembly is autonomously operated by the controller.

10. The self-propelled railcar as claimed in claim 9, the off-board energy storage system further comprising:
a secondary power source, wherein the controller provides energy from the secondary power source to the propulsion motor to the powered axle of the at least one bogie attached to the vehicle in a predetermined manner to control movement of the vehicle.

11. The self-propelled railcar as claimed in claim 10, wherein the secondary power source comprises a battery.

12. The self-propelled railcar as claimed in claim 1, wherein the plurality of sensors include front and rear cameras, radar, lidar, global positional system (GPS) tracking, adaptive speed controllers, and ultrasonic obstacle detection.

13. The self-propelled railcar as claimed in claim 1, wherein the processor of the sensor suite gathers information received from the plurality of sensors and sends said information to the controller.

14. The self-propelled railcar as claimed in claim 13, wherein the controller operates autonomously to control movement of the self-propelled railcar in accordance with the information received from the processor of the sensor suite.

15. The self-propelled railcar as claimed in claim 14, wherein the controller sends the information received from the sensor suite to a remote source, and wherein the controller receives commands from the remote source and controls movement of the self-propelled railcar in conformance with said commands.

16. The self-propelled railcar as claimed in claim 1, wherein the power source comprises a battery.

17. The self-propelled railcar as claimed in claim 15, wherein the battery is lithium titanate oxide.

18. The self-propelled railcar as claimed in claim 1, wherein the power source includes directed energy, drivetrain, hydrogen drivetrain, and large capacitors.

19. A self-propelled railcar comprising:
a structure;
at least one bogie attached to the structure, the bogie having at least one powered axle;
a propulsion motor;
a sensor suite; and
an off-board energy storage system,
wherein the off-board energy storage system comprises a controller and a power source,
wherein the controller provides energy from the power source to propulsion motor to the powered axle in a predetermined manner to control movement of the self-propelled railcar, and
wherein the sensor suite comprises a processor and a plurality of sensors.

20. A self-propelled railcar comprising:
a structure;
at least one bogie attached to the structure, the bogie having at least one powered axle;
a propulsion motor;
a controller;
a sensor suite, the sensor suite comprising a processor and a plurality of sensors; and
an off-board energy storage system, the off-board energy storage system comprising a power source,
wherein the controller provides energy from the power source to the propulsion motor to the powered axle in a predetermined manner to control movement of the self-propelled railcar.
